(19) United States
(12) Patent Application Publication
(10) Pub. No.: US 2017/0154318 A1
(43) Pub. Date: Jun. 1, 2017

(54) INFORMATION PROCESSING METHOD, APPARATUS, AND STORAGE MEDIUM

(71) Applicant: Xiaomi Inc., Beijing (CN)

(72) Inventors: Qian WANG, Beijing (CN); Yin ZHU, Beijing (CN); Shaohua HAO, Beijing (CN)

(73) Assignee: Xiaomi Inc.

(21) Appl. No.: 15/241,491

(22) Filed: Aug. 19, 2016

(30) Foreign Application Priority Data
Dec. 1, 2015 (CN) 201510866549.3

(51) Int. Cl. G06Q 20/10; G06K 7/14; G06K 19/06

(52) U.S. Cl. CPC G06Q 20/102; G06K 19/06037; G06K 7/1417; G06K 19/06112; G06F 3/0481

(57) ABSTRACT

Disclosed includes a method for processing information. The method is performed by a terminal and comprises: receiving first information inputted on an interface of a calculator application; and generating, based on the first information, second information related to a payment application.

### CROSS-REFERENCE TO RELATED APPLICATION

This application is based upon and claims priority to Chinese Patent Application No. 201510866549.3, filed on Dec. 1, 2015, which is incorporated herein by reference in its entirety.

### TECHNICAL FIELD

The present disclosure relates to the field of computer technologies, and more particularly, to an information processing method and apparatus and a storage medium.

### BACKGROUND

Currently, there are various software applications (e.g., mobile apps installed on a mobile terminal) that can be used to perform various operations, such as sending short messages, performing a calculation, paying and transferring money, etc. These mobile apps are typically designed to perform a particular type of operation. For example, a calculator app is typically designed to only perform the calculation task. As a result, such calculator app provides limited functionalities.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, a method for processing information is provided. The method is performed by a terminal and comprises: receiving first information inputted on an interface of a calculator application; and generating, based on the first information, second information related to a payment application.

In another aspect, an apparatus for processing information is provided. The apparatus comprises a processor and a memory configured to store instructions executable by the processor. The processor is configured to: receive first information inputted on an interface of a calculator application; and generate, based on the first information, second information related to a payment application.

In another aspect, a non-transitory computer-readable storage medium is provided. The non-transitory computer-readable storage medium stores instructions that, when executed by one or more processors of a terminal, cause the terminal to perform an information processing method. The method comprises: receiving first information inputted on an interface of a calculator application; and generating, based on the first information, second information related to a payment application.

It is to be understood that both the foregoing general description and the following detailed description are exemplary and explanatory only and are not restrictive of the present disclosure.

### BRIEF DESCRIPTION OF THE DRAWINGS

The accompanying drawings here, which are incorporated in and constitute a part of this specification, illustrate embodiments consistent with the present disclosure and, together with the description, serve to explain the principles of the present disclosure.

FIG. 1 is a flow chart illustrating a method for processing information, according to an exemplary embodiment of the present disclosure.

FIG. 2 is a flow chart illustrating a method for processing information, according to an exemplary embodiment of the present disclosure.

FIG. 3 is a block diagram of an apparatus for processing information, according to an exemplary embodiment of the present disclosure.

FIG. 4 illustrates a block diagram of an apparatus for processing information, according to an exemplary embodiment of the present disclosure.

FIG. 5 illustrates additional components of the apparatus of FIG. 4, according to an exemplary embodiment of the present disclosure.

FIG. 6 illustrates a device in which embodiments of the present disclosure can be implemented.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise presented. The embodiments set forth in the following description of exemplary embodiments do not represent all embodiments consistent with the present disclosure. Instead, they are merely examples of apparatuses and methods consistent with aspects related to the invention as recited in the appended claims.

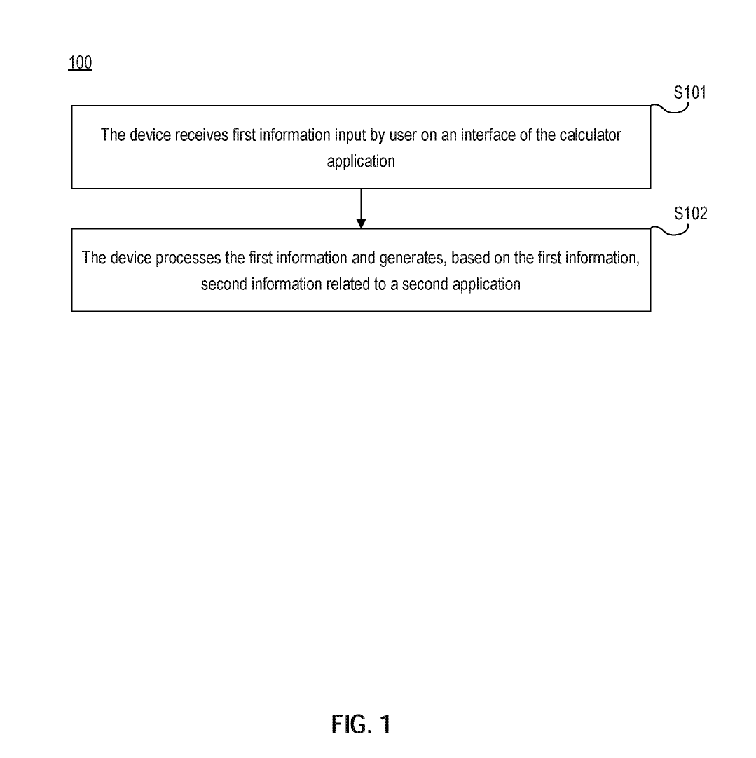

FIG. 1 is a flow chart illustrating a method 100 for processing information, according to an exemplary embodiment of the present disclosure. For example, the method 100 can be used by a device to process information related to a first application and a second application installed on the device. The device can be a mobile phone, a tablet computer, a smart television, etc. The first application can be a calculator application, and the second application can be a payment application. As shown in FIG. 1, method 100 includes steps S101 and S102.

In step S101: the device receives first information input by a user on an interface of the first application.

In step S102: the device processes the first information and generates, based on the first information, second information related to the second application. In some embodiments, as discussed above, the second application may be a payment application, and the second information may include payment information to be processed by the payment application.

With embodiments of the present disclosure, a device can process first information received via an interface of a calculator application and generate, based on the first information, second information related to a payment application. The second information can include, for example, payment information to be transmitted by the payment application. As a result, as the calculator application performs a calculation operation, the output of the calculation operation (or the input to the operation), as displayed on the interface of the calculator application, can be used to generate payment information. The payment information can then be processed by the payment application. The payment information may also be displayed on a display screen of the device, which allows the user to make a payment according to the displayed payment information. As a result, the calculator application can be associated with a wider range of functionalities.

In some embodiments, in step S102, the device may also generate second information based on a two-dimensional code. The two-dimensional code may represent, for example, one or more numeric values displayed in the interface of the calculator application (which can be a part of an input or an output for a calculation operation). The two-dimensional code information can be displayed at a preset position on the display screen of the device, so that another device (e.g., a mobile phone) can receive the two-dimensional code information by, for example, scanning the display screen. For example, the two-dimensional code information may represent payment information. Another device, with a payment application operating, can then scan the display screen to obtain the payment information.

In some embodiments, in step S102, the device may determine whether the device includes a payment application. If the device determines that the payment application is included in the device and is operational, the device can display an identifier of the payment application in the interface of the calculator application. The device can also display an indication to prompt the user to invoke the payment application to process the payment information generated from the first information provided by the calculator application (e.g., by transmitting the payment information to a second device to perform a payment).

With embodiments of the present disclosure, the device can display an identifier of the payment application in the interface of the calculator application. The device can also display an indication to prompt the user to invoke the payment application to process the payment information generated from the first information provided by the calculator application. As a result, the calculator application can be associated with a wider range of functionalities.

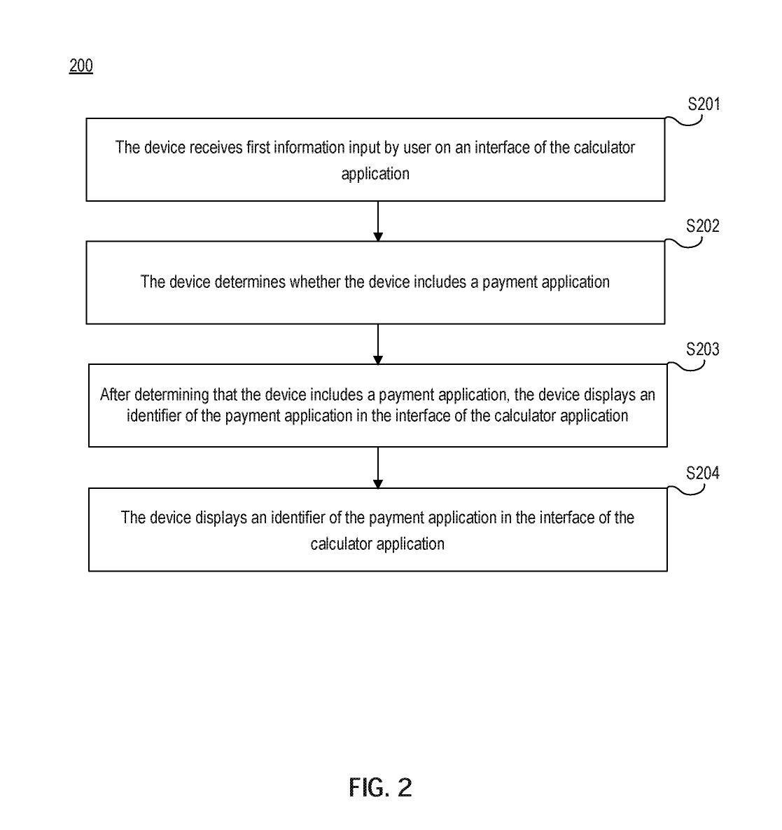

FIG. 2 is a flow chart illustrating a method 200 for processing information, according to an exemplary embodiment of the present disclosure. For example, the method 200 can be used by a device to process information related to a first application and a second application installed on the device. The device can be a mobile phone, a tablet computer, a smart television, etc. The first application can be a calculator application, and the second application can be a payment application. As shown in FIG. 2, method 200 includes steps S201 to S204.

In step S201, the device receives first information input by a user on an interface of the calculator application.

In step S202, the device determines whether the device includes a payment application.

In step S203, after determining that the device includes a payment application, the device displays an identifier of the payment application in the interface of the calculator application.

In step S204, the device displays an identifier of the payment application in the interface of the calculator application. The device can also display an indication to prompt the user to invoke the payment application to process the payment information generated from the first information provided by the calculator application (e.g., by transmitting the payment information to a second device to perform a payment).

In some embodiments, prior to displaying an indication to prompt the user to invoke the payment application, in step S204, the device also performs the following: if the first information is determined to include data associated with a mathematical formula, the device can transmit the data associated with the mathematical formula to a location accessible by the payment application. After the payment application is invoked, the payment application can then perform further processing based on the mathematical formula (e.g., calculating a payment amount).

On the other hand, if the first information is determined to include data associated with one or more numeric values, the device can transmit the data associated with the one or more numeric values to a location accessible by the payment application. After the payment application is invoked, the payment application can process the numeric values (e.g., calculating a payment amount).

In some embodiments, when displaying an indication to prompt the user to invoke the payment application, in step S204, the device can also display an indication to prompt the user to select between providing numeric values or providing a mathematical formula to the payment application, and to prompt the user to use the payment application to perform money transfer or payment according to one of the mathematical formula or the numeric values.

In some embodiment, after the payment application is invoked, the device can further display an indication to prompt the user to enter additional information to the payment application. The additional information can include, for example, information about a target recipient for the payment, to complete a transaction.

With embodiments of the present disclosure, an interface can be provided between a calculator application and a payment application. The device can receive an input of a mathematic formula or one or more numeric values on an interface of the calculator application. After receiving the input, the device can display an identifier (e.g., an icon) of the payment application in the interface of the calculator application to prompt the user to determine whether to invoke the payment application to process an amount of money that corresponds to the input. As a result, the functionalities associated with the calculator application can be expanded.

In the following, a use case for the method 200 is presented.

For example, a user inputs a mathematic formula “120/3” in the interface of the calculator application operating on a mobile terminal. In addition to calculating a result as “40” and displaying the calculated result on its interface, the mobile terminal also determines whether a payment application is installed. If the payment application is installed, the mobile terminal can display an identifier of the payment application on the interface of the calculator application, which allows the user to invoke the payment application. The mobile terminal can also display an indication to prompt the user to determine whether to perform money transfer in an amount of “40”. After receiving a selection to perform the money transfer, the device can display another interface that allows the user to provide additional information (e.g., information about a recipient) to complete the money transfer transaction.

The followings are apparatus embodiments of the present disclosure, which may be configured to perform the method embodiments of the present disclosure. For details that are not disclosed in the apparatus embodiments of the present disclosure, reference can be made to the method embodiments of the present disclosure.

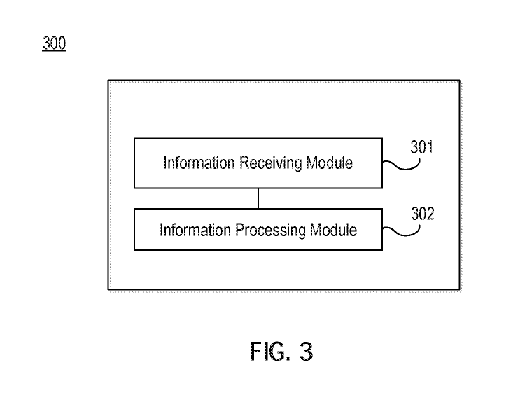

FIG. 3 is a block diagram of an apparatus 300 for processing information, according to an exemplary embodiment of the present disclosure. For example, the apparatus 300 can process information related to a first application and a second application. The first application can be a calculator application. The second application can be a payment application. The apparatus 300 can be implemented by software, hardware, or a combination thereof as a mobile terminal, or as a part of a mobile terminal. The mobile terminal can be a mobile phone, a tablet computer, a smart television, etc. As shown in FIG. 3, the apparatus 300 includes an information receiving module 301 and an information processing module 302.

In some embodiments, the information receiving module 301 is configured to receive first information input by a user on an interface of the calculator application.

In some embodiments, the information processing module 302 is configured to process the first information and generate, based on the first information, second information related to the payment application. The second information may include payment information to be processed by the payment application.

Optionally, the information processing module 302 may be configured to generate two-dimensional code payment information according to the first information received by the information receiving module 301.

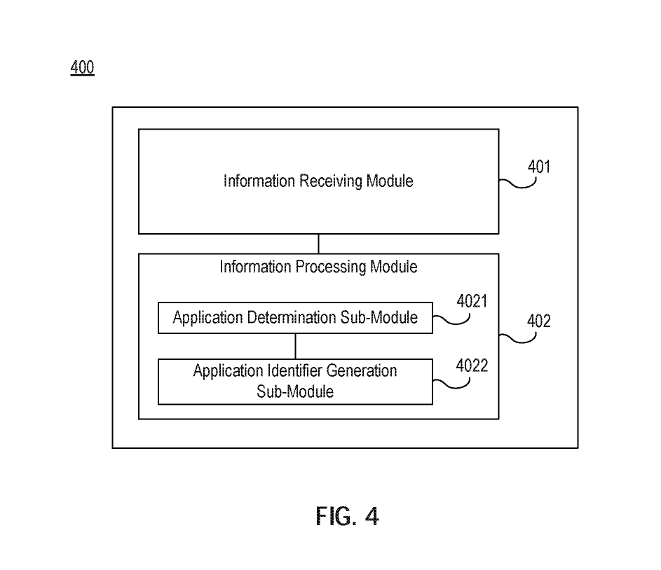

FIG. 4 is a block diagram of an apparatus 400 for processing information, according to an exemplary embodiment of the present disclosure. For example, the apparatus 400 can process information related to a first application and a second application. The first application can be a calculator application, and the second application can be a payment application. The apparatus 400 may be implemented by software, hardware, or a combination thereof as a mobile terminal, or a part of the mobile terminal. The mobile terminal can be a mobile phone, a tablet computer, a smart television, etc. As shown in FIG. 4, the apparatus 400 includes an information receiving module 401 and an information processing module 402.

In some embodiments, the information receiving module 401 is configured to receive first information input by a user on an interface of the calculator application.

In some embodiments, the information processing module 402 is configured to process the first information and generate, based on the first information, second information related to the payment application. The second information may include payment information to be processed by the payment application.

In some embodiments, as shown in FIG. 4, the information processing module 402 further includes an application determination sub-module 4021 and an application identifier generation sub-module 4022.

In some embodiments, the application determination sub-module 4021 is configured to determine whether the mobile terminal includes a payment application.

In some embodiments, the application identifier generation sub-module 4022 is configured to, after determining that the device includes a payment application, generate and display an identifier of the payment application on the interface of the payment application. The application identifier generation sub-module 4022 can also display an indication to prompt the user to invoke the payment application to process the payment information generated from the first information provided by the calculator application (e.g., by transmitting the payment information to a second device to perform a payment).

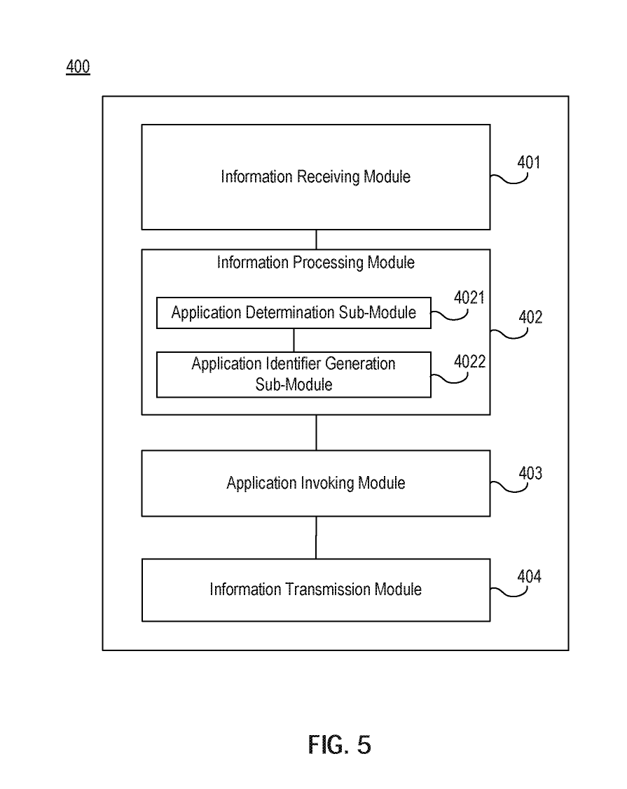

FIG. 5 illustrates additional components of the apparatus 400 of FIG. 4, according to an exemplary embodiment of the present disclosure. As shown in FIG. 5, the apparatus 400 can further include an application invoking module 403 and an information transmission module 404.

In some embodiments, the application invoking module 403 is configured to, after receiving the first information from the calculator application, invoke the payment application. If the first information includes a mathematical formula, the application invoking module 403 can also pass data of the mathematical formula to the payment application, which can then perform further processing based on the mathematical formula.

Optionally, the application determination sub-module 4022 is configured to display an indication to prompt the user to select between providing numeric values or providing a mathematical formula to the payment application, and to prompt the user to use the payment application to perform money transfer or payment according to one of the mathematical formula or the numeric values.

In some embodiments, as shown in FIG. 5, the apparatus 400 further includes an information transmission module 404 configured to prompt the user to enter additional information to the payment application. The additional information can include, for example, information about a target recipient for the payment, to complete a transaction.

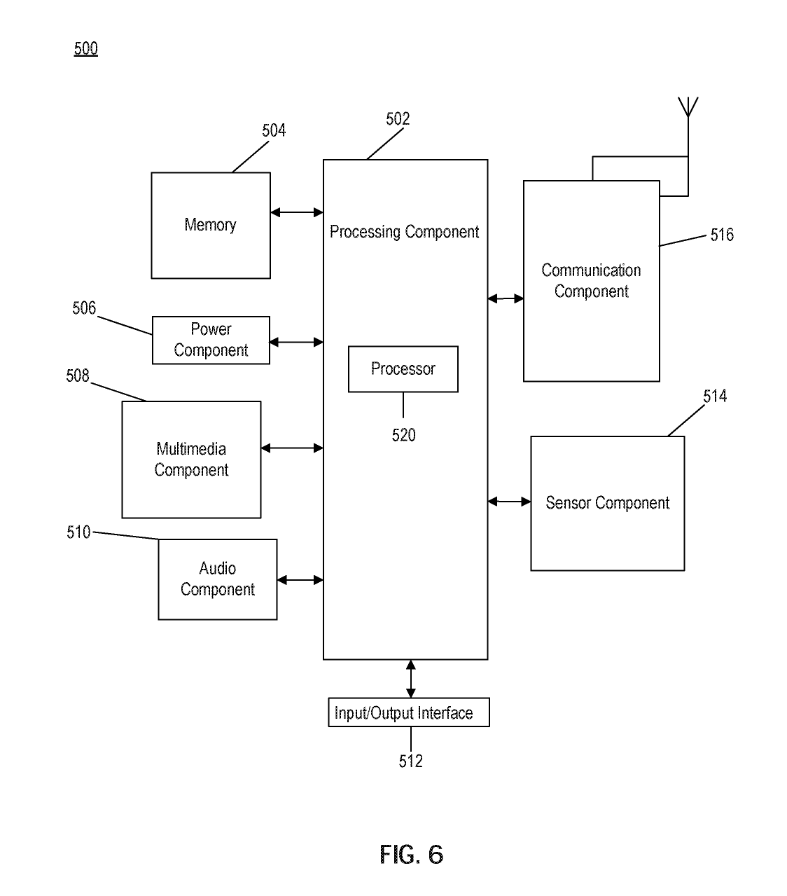

FIG. 6 is a block diagram illustrating an apparatus 500 for processing information, according to an exemplary embodiment of the present disclosure. For example, the apparatus 500 may be a mobile phone, a tablet computer and a smart television, and the like.

Referring to FIG. 6, the apparatus 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the apparatus 500, such as the operations associated with display, telephone calls, data communications, camera operations, and recording operations. The processing component 502 may include one or more processors 520 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the apparatus 500. Examples of such data include instructions for any applications or methods operated on the apparatus 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk. The memory 504 can include a non-transitory computer readable medium to store instructions that correspond to any of the modules and sub-modules of FIG. 3, FIG. 4, and FIG. 5. The instructions, when executed by the one or more processors 520 of the processing component 502, can also cause the one or more processors 520 to perform, for example, the method 100 of FIG. 1 and the method 200 of FIG. 2.

The power component 506 provides power to various components of the apparatus 500. The power component 506 may include a power management device, one or more power sources, and any other components associated with the generation, management, and distribution of power in the apparatus 500.

The multimedia component 508 includes a screen providing an output interface between the apparatus 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and the rear camera may receive an external multimedia datum while the apparatus 500 is in an operation mode, such as a photographing mode or a video mode. Each of the front camera and the rear camera may be a fixed optical lens device or have focus and optical zoom capability.

The audio component 510 is configured to output and/or input audio signals. For example, the audio component 510 includes a microphone (MIC) configured to receive an external audio signal when the apparatus 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the apparatus 500. For instance, the sensor component 514 may detect an open/closed status of the apparatus 500, relative positioning of components, e.g., the display and the keypad, of the apparatus 500, a change in position of the apparatus 500 or a component of the apparatus 500, a presence or absence of user contact with the apparatus 500, an orientation or an acceleration/deceleration of the apparatus 500, and a change in temperature of the apparatus 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the apparatus 500 and other devices. The apparatus 500 may access a wireless network based on a communication standard, such as WiFi, 2G, or 3G, or a combination thereof. In one exemplary embodiment, the communication component 516 receives a broadcast signal or broadcast associated information from an external broadcast management system via a broadcast channel In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 504, executable by the processor 520 in the apparatus 500, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium is provided, and when instructions in the storage medium are executed by a processor of an apparatus 500, the apparatus 500 is enabled to perform the above-described information processing method.

It will be appreciated that the present invention is not limited to the exact construction that has been described above and illustrated in the accompanying drawings, and that various modifications and changes may be made without departing from the scope thereof. It is intended that the scope of the invention only be limited by the appended claims.

1. A method for processing information, the method being performed by a terminal and comprising:
receiving first information inputted on an interface of a calculator application; and
generating, based on the first information, second information related to a payment application.

2. The method according to claim 1, wherein generating second information related to a payment application comprises:
generating two-dimensional code information based on the first information; and
displaying the two-dimensional code information on a display screen of the terminal.

3. The method according to claim 1, wherein generating second information related to a payment application comprises:
determining whether the terminal includes the payment application installed thereon;
after determining that the terminal includes the payment application installed thereon:
displaying an identifier of the payment application on a display screen of the terminal, when the terminal has the payment application installed thereon, and
displaying a first indication in the interface of the calculator application to prompt a user to invoke the payment application.

4. The method according to claim 3, further comprising:
prior to displaying the first indication to prompt a user to invoke the payment application, detecting whether the first information includes a mathematical formula or numeric values;
if the first information includes a mathematical formula:
invoking the payment application, and
providing the mathematical formula to the payment application to enable the payment application to generate the second information based on the mathematical formula;
if the first information includes numeric values:
invoking the payment application, and
providing the numeric values to the payment application to enable the payment application to generate the second information based on the numeric values.

5. The method according to claim 4, wherein displaying a first indication to prompt a user to invoke the payment application comprises: displaying the first indication to prompt the user to use the payment application to perform money transfer or payment according to one of the mathematical formula or the numeric values.

6. The method according to claim 5, further comprising:
displaying a second indication to prompt the user to enter additional information to the payment application; wherein the additional information include information about a target recipient for the payment.

7. An apparatus for processing information, comprising:
a processor;
a memory configured to store instructions executable by the processor;
wherein the processor is configured to:
receive first information inputted on an interface of a calculator application; and
generate, based on the first information, second information related to a payment application.

8. The apparatus according to claim 7, wherein the processor is further configured to:
generate two-dimensional code information based on the first information; and
display the two-dimensional code information on a display screen of the apparatus.

9. The apparatus according to claim 7, wherein the processor is further configured to:
determine whether the apparatus includes the payment application installed thereon;
after determining that the apparatus includes the payment application installed thereon:
display an identifier of the payment application on a display screen of the apparatus, when the apparatus has the payment application installed thereon, and
display a first indication in the interface of the calculator application to prompt a user to invoke the payment application.

10. The apparatus according to claim 9, wherein the processor is further configured to:
prior to displaying the first indication to prompt a user to invoke the payment application, detect whether the first information includes a mathematical formula or numeric values;
if the first information includes a mathematical formula:
invoke the payment application, and
provide the mathematical formula to the payment application to enable the payment application to generate the second information based on the mathematical formula;
if the first information includes numeric values:
invoke the payment application, and
provide the numeric values to the payment application to enable the payment application to generate the second information based on the numeric values.

11. The apparatus according to claim 10, wherein the processor is further configured to: displaying the first indication to prompt the user to use the payment application to perform money transfer or payment according to one of the mathematical formula or the numeric values.

12. The apparatus according to claim 11, wherein the processor is further configured to: display a second indication to prompt the user to enter additional information to the payment application; wherein the additional information includes information about a target recipient for the payment.

13. A non-transitory computer-readable storage medium having stored therein instructions that, when executed by a processor of a terminal, cause the terminal to perform an information processing method, the method comprising:
receiving first information inputted on an interface of a calculator application; and
generating, based on the first information, second information related to a payment application.

14. The medium according to claim 13, wherein generating second information related to a payment application comprises:
generating two-dimensional code information based on the first information; and
displaying the two-dimensional code information on a display screen of the terminal.

15. The medium according to claim 13, wherein generating second information related to a payment application comprises:
determining whether the terminal includes the payment application installed thereon;
after determining that the terminal includes the payment application installed thereon:
displaying an identifier of the payment application on a display screen of the terminal, when the terminal has the payment application installed thereon, and
displaying a first indication in the interface of the calculator application to prompt a user to invoke the payment application.

16. The medium according to claim 15, wherein the method further comprises:
prior to displaying the first indication to prompt a user to invoke the payment application, detecting whether the first information includes a mathematical formula or numeric values;
if the first information includes a mathematical formula:
invoking the payment application, and
providing the mathematical formula to the payment application to enable the payment application to generate the second information based on the mathematical formula;
if the first information includes numeric values:
invoking the payment application, and
providing the numeric values to the payment application to enable the payment application to generate the second information based on the numeric values.

17. The medium according to claim 16, wherein displaying a first indication to prompt a user to invoke the payment application comprises: displaying the first indication to prompt the user to use the payment application to perform money transfer or payment according to one of the mathematical formula or the numeric values.

18. The medium according to claim 16, wherein the method further comprises:
displaying a second indication to prompt the user to enter additional information to the payment application; wherein the additional information include information about a target recipient for the payment.
